(19) United States
(12) Patent Application Publication
(10) Pub. No.: US 2005/0171330 A1
(43) Pub. Date: Aug. 4, 2005

(54) Resin paste degradable and absorbable in vivo and manufacturing method thereof

(76) Inventors: Suong-Hyu Hyon, Kyoto (JP); Naoki Nakajima, Kyoto (JP)

Correspondence Address: JORDAN AND HAMBURG LLP, 122 EAST 42ND STREET, SUITE 4000, NEW YORK, NY, 10168, US

(21) Appl. No.: 11/050,517

(22) Filed: Feb. 3, 2005

(30) Foreign Application Priority Data
Feb. 3, 2004 (JP) 2004-61329

(51) Int. Cl. C08G 63/08

(52) U.S. Cl. 528/354

(57) ABSTRACT

A resin paste degradable and absorbable in vivo consisting essentially of a co-oligomer of lactide and ε-caprolactone having weight-average molecular weight in a range from 2000 through 10,000. Reaction for preparing the co-oligomer is made in a presence of alcohol of C₂-C₁₈ or its ester with aliphatic or alicyclic acid, which are added by 5 through 45 weight % to the mixture of lactide and ε-caprolactone. The alcohol is preferably lauryl alcohol (1-dodecanol), stearyl alcohol (1-octadecanol), ethylene glycol or polyethylene glycol. Meanwhile, especially preferable ester is ethyl lactate.

### TECHNICAL FIELD

This invention relates to resin pastes degradable and absorbable in a living body, and to its manufacturing method. Such polymers are useful in biomedical application such as sealant, adhesion prevention material, pressure-sensitive adhesive or tackifier, and viscosity improver.

### BACKGROUND ART

Conventionally, polymers degradable and absorbable in vivo including poly(lactic acid), poly(glycolic acid), and polycaprolactone have been known and used as surgical sutures, bone fasteners and the like. Whereas such in-vivo degradable and absorbable polymers are divided into homopolymers and copolymers, the coplymers are preferred because mechanical property and in vivo degradability are controllable. As one of such copolymer, lactide/ε-caprolactone copolymer is disclosed in JP-2000-191753A (Japanese unexamined Patent Publication 2000-191753) for example. Although the lactide/ε-caprolactone copolymer has low content of metal, high safety and flexibility, the copolymer has been known to be not flowable and thus not suitable for sealants or the like. Meanwhile, fluid polymers having poor viscosity are not suitable for biomedical resin such as the sealant, adhesion prevention material.

It is aimed to provide an in-vivo degradable and absorbable resin paste that is flowable and has adequately high viscosity for biomedical use.

### BRIEF SUMMARY OF THE INVENTION

The invention-wise resin paste degradable and absorbable in vivo is consisting essentially of a co-oligomer of lactide and ε-caprolactone having a weight-average molecular weight in a range from 2000 through 10,000. The invention-wise resin paste is a flowable and viscose paste, thus is easy to be applied during surgery operation or medical treatment. Molar ratio of lactide to ε-caprolactone (lactide/ε-caprolactone) is preferably in a range from 70/30 through 30/70, and more preferably in a range from 55/45 through 45/55. At outside of this range, viscosity of the polymer tends to be too high. Higher content of lactide leads to higher glass transition temperature of the co-oligomer, while higher content of caprolactone leads to high crystalinity. Thus, in both cases, the co-oligomer becomes stiff.

Lactide in any of D-form, L-form and DL-form is suitably used for forming the invention-wise co-oligomer. Viscosity of the invention-wise co-oligomer is preferably in a range from 500 through 100,000 mPa·sec at 25° C. Weight-average molecular weight of the co-oligomer is preferably in a range from 2500 through 5000.

Invention-wise method of manufacturing the in-vivo degradable and absorbable polymer comprises: preparing mixture of lactide and ε-caprolactone monomers; admixing alcohols of C₂-C₁₈ (formed of carbon chain consisting of two through eighteen carbon atoms) or its ester with an aliphatic or alicyclic acid, to the mixture, by 5 through 45 weight % of the mixture; and then oligomerizing the mixture. In this way, it is easy to obtain a pasty, flowable and viscose resin that is degradable and absorbable in vivo. In the method, molar ratio of lactide/ε-caprolactone is preferably in a range from 70/30 through 30/70, and more preferably in a range from 55/45 through 45/55.

### DETAILED DESCRIPTION OF THE INVENTION

The alcohol compounds may be any of aliphatic or alicyclic alcohols having one, two or more hydroxyl groups. Preferable examples of the alcohols compounds are lauryl alcohol (1-dodecanol), stearyl alcohol (1-octadecanol), ethylene glycol and polyethyleneglycol. In the invention-wise method, ester of such alcohols may alternatively be used. The ester is preferably any combination between (1) an acid selected from a group consisting of lactic acid, glycolic acid and hydroxy capronic acid (hydroxy hexanoic acid) and (2) an alcohols compound selected from a group consisting of methanol, ethanol, butanol, pentanol, hexanol and nonyl alcohol. Among them, ethyl lactate is especially preferred.

Ratio of admixing the alcohol or ester to the mixture of the lactide and ε-caprolactone is in a range from 5 through 45 weight % (phr), more preferably in a range from 10 through 30 weight % (phr).

Temperature at polymerization reaction is preferably in a range from 120° C. through 160° C. When the temperature is below this range, the polymerization reaction requires too long time and product polymer has poor fluidity due to increased tendency to block polymerization. Meanwhile, when the temperature is above the range, decomposition of the polymer takes place and coloring become significant. More preferable range of the polymerization temperature is in a range from 135° C. through 145° C.

Duration of the polymerization is preferably in a range from one through ten days. The duration shorter than one day would not be enough for required extent of oligomerization; and the duration longer than ten days is not economically suitable. The duration of the oligomerizaion is more preferably in a range from one through four days.

In the invention-wise manufacturing method, the polymerization is made preferably in presence of metal catalyst, for example, in presence of dibutyl tin laurate or tin octanoate (tin octylate). Ratio of admixing the metal catalyst to the mixture of lactide and ε-caprolactone is preferably in a range from 0.01 through 0.1 weight % (phr) and more preferably in a range from 0.02 through 0.04 weight %.

The monomers of lactide and ε-caprolactone are preferably purified on beforehand of use as to eliminate impurities. Purification of the lactide monomer may be made by recrystalization in toluene or ethyl acetate that has been dried with natrium, for example. Meanwhile, purification of the ε-caprolactone may be made by distillation under reduced pressure with nitrogen replacement. The polymerization is preferably made by bulk polymerization in a reactor or flask that has been purged of air at inside by vacuuming and then sealed at reduced pressure.

The invention-wise resin is pasty, flowable and viscose, and is thus easy to be handled during surgery operation or medical treatment. Resultantly, the resin is suitably applied as biomedical materials such as sealant, adhesion prevention material, tackifier or pressure-sensitive adhesive, and thickening agent or viscosity improver.

### EXAMPLE 1

56 g of L-lactide monomer and 44 g of ε-caprolactone monomer were charged, that makes 50/50 molar ratio, into an egg-shaped or round-bottom single-neck glass flask of 100 ml capacity. Then, the mixture of the monomers was added with lauryl alcohol (1-dodecanol) by 15 weight % (phr) and with tin octanoate by 0.03 weight %. Thereafter, the flask was purged of air by vacuuming and was sealed under such vacuumed condition. Subsequently, the flask was placed in an oil bath maintained at 140° C., as to proceed the oligomerization or polymerization, for three days. Obtained resin was evaluated in respect of state at room temperature as well as of weight-average molecular weight.

A resin of a first comparative example was prepared by a procedure merely omitting use of the lauryl alcohol from the above procedure of the Example 1.

The measurement of the molecular weight was made by a gel permeation chromatography (GPC) or size exclusion chromatography (SEC), in which adopted are: a liquid chromatography apparatus “HLC-8020” of TOSOH Corporation; tetrahydrofuran as moving phase or eluant; chromatography columns of TSK-GEL G3000HXL and TSK-GEL G5000HXL in a serial connection; temperature of the columns at 40° C.; and a flow rate of the moving phase (tetrahydrofuran) at 0.5 ml/minute. Standard polystyrene samples were used for creating a calibration curve as to evaluate molecular weight of the obtained polymers.

Resultant resin of the Example 1 had a weight-average molecular weight of 3800 and is a viscose paste. On contrary, resultant resin of the first comparative example had a molecular weight of 350,000 and was in a rubber form showing no flowability.

A resin of second comparative example was prepared by charging 24 g of L-lactide monomer and 76 g of ε-caprolactone monomer were charged, with 20/80 molar ratio, into the flask and by a procedure otherwise same as the Example 1. The resultant polymer was in a rubber form showing no fluidity, as same manner as the first comparative example.

### EXAMPLE 2

27.9 g of L-lactide monomer and 22.1 g of ε-caprolactone monomer were charged, which makes 50/50 molar ratio, into a test tube of 30 mm diameter. Then, the mixture of the monomers were added with lauryl alcohol (1-dodecanol) by either of 1, 20, 30 and 50 weight % or phr and with tin octanoate by 0.03 weight % or phr. Thereafter, the flask was purged of air at inside by vacuuming and was then sealed under such vacuumed condition. Subsequently, the flask was placed in an oil bath maintained at 140° C., as to proceed the polymerization, for two days. Obtained polymer was evaluated in respect of state at room temperature as well as of weight-average molecular weight and viscosity of the obtained polymer.

The viscosity of the polymer was measured by a “B-type rotational viscometer” of TOKIMEC Inc. with “No. 4” rotor, at which polymer samples were placed in solid-mouthed plastic bottle of 50 ml capacity and were kept at 25° C. Molecular weight of the polymer samples was measured in a same manner as the Example 1.

TABLE
Effect of amount of alcohol addition

| Amount of | | | |
|---|---|---|---|
| lauryl alcohol | Weight-average | Viscosity | |
| (wt % or phr) | Molecular weight | mPa · sec | Nature |
| 1 | 41652 | beyond capacity | rubber |
| 10 | 4800 | 96600 | paste |
| 20 | 3610 | 6000 | paste |
| 30 | 2440 | 2250 | paste |
| 50 | 1491 | 260 | liquid |

As shown in the table, when the amount of alcohol addition is 1 wt % to the monomer mixture, obtained resin was a rubber showing no fluidity, at 25° C.; and viscosity of which was beyond capacity of the measurement that is 100,000 mPa·sec (cP; centi Poise). Meanwhile, when the amount of alcohol addition was in a range from 10 through 30 wt % to the monomer mixture, obtained resins were viscose paste. When the amount of alcohol addition was 50 wt %, obtained oligomer was a liquid having poor viscosity.

### EXAMPLE 3

139.5 g of L-lactide monomer and 110.5 g of ε-caprolactone monomer were charged, which makes 50/50 molar ratio, into an egg-shaped or round-bottom single-neck flask of 300 ml capacity. Then, the mixture of the monomers was added with ethyl lactate by 15 weight % or phr and with tin octanoate by 0.03 weight % or phr. Thereafter, the flask was purged of air at its inside by vacuuming and then was sealed under such vacuumed condition. Subsequently, the flask was placed in an oil bath maintained at 140° C., as to proceed the polymerization, for two days. Obtained polymer was evaluated in a same manner as the Example 2.

Resultant polymer is a viscose paste with viscosity of 17,500 mPa·sec (cP) at 25° C. and has a weight-average molecular weight of 2759.

### EXAMPLE 4

167.4 g of L-lactide monomer and 132.6 g of ε-caprolactone monomer were charged, with 50/50 molar ratio, into an egg-shaped or round-bottom single-neck flask of 300 ml capacity. Then, the mixture of the monomers was added with ethyl lactate by 13 weight % or phr and with tin octanoate by 0.03 weight % or phr. Thereafter, the flask was purged of air inside thereof by vacuuming and was then sealed under such vacuumed condition. Subsequently, the flask was placed in an oil bath maintained at 140° C., as to proceed the polymerization, for two days. Obtained polymer was evaluated in a same manner as the Example 1. Resultant polymer is a viscose paste at 25° C. and has a weight-average molecular weight of 3793.

### CROSS-REFERENCE TO RELATED APPLICATION

This application is based upon and claims the benefits of priority from the prior Japanese Patent Application No. 2004-61329 filed on Feb. 5, 2004; the contents of which is incorporated herein by reference.

1. A resin paste degradable and absorbable in vivo consisting essentially of a co-oligomer of lactide and E-caprolactone having weight-average molecular weight in a range from 2000 through 10,000; molar ratio of lactide to ε-caprolactone being in a range from 70/30 through 30/70; and viscosity of the co-oligomer per se being in a range from 500 through 10,000 mPa·sec at 25° C.

2. A method of manufacturing a resin paste degradable and absorbable in vivo, comprising: preparing mixture of lactide and ε-caprolactone monomers; admixing alcohols having carbon chain atoms in a range from two through eighteen or ester of said alcohols with aliphatic or alicyclic acid, to the mixture, by 5 through 45 weight % of the mixture; and then oligomerizing the mixture.

3. A method of manufacturing a resin paste degradable and absorbable in vivo according to claim 2, molar ratio of lactide to s-caprolactone being in a range from 70/30 through 30/70; and temperature of said oligomerizing being in a range from 120° C. through 160° C.

4. A method of manufacturing a resin paste degradable and absorbable in vivo according to claim 3, wherein said mixture is admixed with at least one selected from a group consisting of lauryl alcohol (1-dodecanol), stearyl alcohol (1-octadecanol), ethylene glycol and polyethylene glycol.

5. A method of manufacturing a resin paste degradable and absorbable in vivo according to claim 3, wherein said mixture is admixed with at least one ester that is combination between (1) an acid selected from a group consisting of lactic acid, glycolic acid and hydroxy capronic acid (hydroxy hexanoic acid) and (2) an alcohol selected from a group consisting of methanol, ethanol, butanol, pentanol, hexanol and nonyl alcohol.

6. A method of manufacturing a resin paste degradable and absorbable in vivo according to claim 4, wherein said mixture is admixed with ethyl lactate.

7. A method of manufacturing a resin paste degradable and absorbable in vivo according to claim 3, duration of said oligomerizing being in a range from 1 day through 10 days.

8. A method of manufacturing a resin paste degradable and absorbable in vivo according to claim 7, further comprising admixing of metal catalyst before said oligomerizing, by 0.01 through 0.1 weight % to said mixture.
